(19) United States
(12) Patent Application Publication
(10) Pub. No.: US 2016/0155162 A1
(43) Pub. Date: Jun. 2, 2016

(54) Systems and Methods for Online Interactive Social Shopping

(71) Applicant: Jacqueline Gagnon-Volles, Naperville, IL (US)

(72) Inventor: Jacqueline Gagnon-Volles, Naperville, IL (US)

(21) Appl. No.: 14/924,008

(22) Filed: Oct. 27, 2015

Related U.S. Application Data
(60) Provisional application No. 62/068,809, filed on Oct. 27, 2014.

(51) Int. Cl. G06Q 30/06

(52) U.S. Cl. CPC G06Q 30/0605; G06Q 30/0641; G06Q 30/0633

(57) ABSTRACT

The present invention relates to systems and methods for an on-line social shopping network or platform. Specifically, the present disclosure provides an on-line, interactive group selling and shopping platform, facilitated by a consultant, which allows consumers to shop together online wherever they may be located, while viewing and participating in a real time event.

The present invention claims priority to U.S. Provisional Patent Application No. 62/068,809, filed on Oct. 27, 2014, which is incorporated herein by reference in its entirety.

### TECHNICAL FIELD

The present invention relates to systems and methods for an online, interactive social shopping platform. More specifically, a website facilitates an online, interactive group selling and shopping platform arranged by a hostess and facilitated by a consultant or independent sales representative, which allows friends and family to shop together online wherever they may be located. The present system also provides a broad range of URLs connected to a single online selling and shopping platform.

### BACKGROUND

Direct selling, also referred to as a multi-level marketing model, is a method of marketing products by hosting a social event where the products will be offered for sale, i.e., the Tupperware “party.” Tupperware, which started in 1946, is possibly one of the best-known retailers for providing the in-home shopping experience. Other retailers followed, including Mary Kay, Pampered Chef and Tastefully Simple, among many others. It is certain that the in-home shopping experience of “people selling to people,” where hostesses and consultants invite friends and relatives to their homes to socialize and share in the shopping and buying experience, is a model that has worked for many years. However, the party plan has been limited to the home experience. Recently, some direct sellers have added the ability for consumers to buy direct, but they have not added the live social component to the online shopping experience.

Certainly, the face of retail is changing. The way Millennials shop and purchase products is different from the shopping style of Generation X and Baby Boomers. Millennials are comfortable seeking or gathering information on brands and products from any source available to them, relying on the Internet as one of many sources. The Internet has also become a primary source for buying and selling goods and/or services. Specifically, since the time of interconnected computers, means developed quickly to facilitate commerce. As the Internet has grown and developed, a robust marketplace has appeared where buyers can find and purchase most anything that is available by sellers. Moreover, jurisdictional boundaries have diminished and, in some cases, have disappeared as purchasers take advantage of the Internet for purchasing goods and/or services in other states, countries and continents.

Because the Internet is so prevalent to consumers, billions of dollars exchange hands through buying and selling of goods via the Internet. For example, the well-known online marketplace, eBay®, is an online auction site where users bid on items placed for sale by potential purchasers. Another well-known on-line marketplace is Etsy. Etsy brings together small business owners and artisans from all over the world with consumers through its on-line marketplace. Through Etsy, consumers are exposed to unique, often hand-made products, which can be purchased directly from the artisan. Similarly, artisans are able to bring their talents and wares to thousands of potential consumers they would otherwise not reach through conventional means.

Although the Internet can be useful for buying and selling items, it can be an overwhelming experience. Nearly everything is available online, and the multitude of products and array of choices creates an “endless aisle” that can be overwhelming for the shopper. Furthermore, the Internet can appear sterile and void of the social shopping experience and comradery found at the in-home shopping party or the brick and mortar shopping experience. However, it is clear that the Internet is and will remain a source of shopping for the consumer. According to Internet Retailer, by 2017, 60% of retail will be influenced by the Internet, while only 10% of actual purchases will be completed on-line. Furthermore, social media marketing facilitates brand discussions among consumers (it is always easy to find someone posting his or her opinion about just about any product found on the Internet) appear to be growing. Therefore, although consumers research and discuss products on-line, they still seek and enjoy one-on-one social interaction in purchasing products in a brick and mortar environment.

The Internet has shifted from being a reference tool to being a research tool and a social tool. Websites such as FacebookTM and MySpaceTM allow for the instant or nearly instantaneous connection of individuals in a social setting. For example, FacebookTM allows a user to sign in and provide information about him or herself, creating a FacebookTM page to post information. In many cases, the information may be updatable quickly by a user. For example, a user may have a page with information contained thereon, and the user may quickly update the information, or add information to the page using Facebook's editing features. Moreover, users may upload digital photographs, information, links, videos, sounds, and other like packets of information to their pages for instant access by those whom they have “friended” on the site. FacebookTM also provides the ability for users to search for one another, connecting to each other so that the users may instantly or nearly instantly inform others of particular information. Additionally, the instant messaging and feedback have clearly evolved into a primary source of communication with Twitter, Instagram and Snapchat, which have only reinforced the human desire for feedback in sharing and daily activities.

Yet, despite this very social aspect of the Internet, it is still not possible to shop together on-line during a real-time live event. Consumers can game together, chat together, share ideas, pictures, thoughts, ratings, all on the various social networking sites provided through the Internet. However, it is not yet possible for friends to get together from remote locations, online, to interact, view and purchase products, like they can at a brick and mortar store or the classic home party.

A need, therefore, exists for improved systems and methods for providing an online, live social shopping platform or network. Specifically, a need exists for improved systems and methods providing on-line, interactive group shopping and selling platform, arranged by a hostess and facilitated by a consultant, which allows friends to shop together wherever they may be located.

Moreover, a need exists for improved systems and methods for providing an online, live social shopping platform to meet the needs of consumers wanting to have access to products anytime and anywhere.

In addition, a need exists for improved systems and methods for providing an online, live social shopping platform or network that invites consumer trust in friends and family when making purchasing decisions.

A need further exists for improved systems and methods for providing an online, live social shopping platform that provides business, entrepreneurs and artisans and engaging and personalized access to serve a broader customer base.

A need further exists for improved systems and methods for providing an online, live social shopping platform that provides artisans, businesses and entrepreneurs with access to the consumer through a trained sales team that curates the assortments and products at a personal level, which cuts through the sea of data available through other sources, such as Ebay and Etsy.

A need further exists for improved systems and methods for providing brands on an online, live social shopping platform that provides businesses with a new method of engagement with consumers by showcasing their products in a live, online shopping event.

A need further exists for improved systems and methods for providing an online social shopping platform that accommodates flexible work schedules for stay-at-home independent consultants.

A need further exists for improved systems and methods for providing an online, live social shopping platform that provides an avenue to facilitate the social aspect of purchasing.

A need further exists for improved systems and methods for providing an online, live social shopping platform that provides a curated assortment of products, eliminating the mired of options through competitor sites and the consumer needing to search through the “endless aisle” of products.

A need further exists for improved systems and methods for providing an online, live social shopping platform that offers assortments broader than other multi-level marketing plans, which offers multiple stores through multiple URLs connecting to a single platform, and provides customized options based on a hostesses likes or preferences.

Additionally, a need exists for improved systems and methods for providing an online, live social shopping network that provides an online platform offering guest lists from several locations.

Furthermore, a need exists for improved systems and methods providing interactive, collaborative selling programs and feedback availability in real time.

### SUMMARY

Systems and methods for interactively linking buyers and sellers of goods, and possibly services, online through a multi-faceted event page, wherein the shopping and selling happens in real time, are provided. Specifically, an online, live social shopping method and system platform is provided, which offers an online party planning and attending site. The party planning and attending site utilizes a host (the term “host” should be considered gender neutral, and may also include a company or brand representative) with consultant/presentor demonstrations (the term “consultant” may also be referred to as “independent sales representative or agent,” or “curator”), live video chat room facilities for live discussion and sharing of comments from remote guests (the term “guest” may also be referred to as friends, family, customers, consumers or navigators) during live demonstrations, and shopping cart access on the event page. The system also provides additional shopping features, including multiple, integrated shopping carts to facilitate purchases and a wish list, permitting the hostess and consultants to effect sales and consolidate data in real time.

To this end, in an embodiment, a method for providing an online, integrated shopping platform is provided. The method comprises the steps of: providing an online social shopping platform including providing a site with multiple store domains; offering a multi-faceted event page serving as a central event for all stores; offering at least one product image within each event page; linking the event page to a plurality of shopping carts; and providing a live link within the event page, wherein a remote customer can visit the event page, comment on an item and make a purchase during a live presentation.

In another embodiment, an online interactive shopping platform, available to various electronic devices through connection to a server, is provided. The platform comprises a home page housing multiple storefront domains and a multi-faceted event page. The event page is viewable by at least one remote consumer using a personal electronic device. The platform accommodates multiple, simultaneous attendees during an online event. Specifically, within the event page, a consultant can navigate a presentation of various products, videos and personal demonstrations through embedded windows, while the platform also allowing guests to navigate a portion of the screen to shop the products being presented. The embedded event includes a chat room that allows all event attendees, including the consultant and the remote guest to share the shopping experience in real time, no matter where they are located.

In an embodiment, the multi-faceted event page further includes live interactive video conferencing for consultants, host/hostesses and remote guests.

In an embodiment, the multi-faceted event page further includes access to a plurality of product or item images.

In an embodiment, the platform further includes at least one shopping cart for accepting products being purchased by the guest during the presentation.

In an embodiment, the platform includes a URL text link for use by a guest to invite to a remote guest for instant feedback and participation during the presentation.

In yet another embodiment, a system for providing an interactive group online shopping experience, is provided. The system comprises a home page with multiple storefront domains within a merchant electronic computing device, a multi-faceted event page, the event page capable of offering a live presentation viewable by at least one remote consumer, at least one product image within each event page, wherein the consumer through its own electronic device can to attend the presentation in real time, comment on the products being presented, and control a gallery of products for possible purchase during the live presentation.

In yet another embodiment, a system for providing an interactive group online shopping experience is provided. The system comprises a multifaceted event page for hosting an online party in real time, the event page further comprising a product presentation area, a video presentation area including a live video of attendees including a consultant and at least one guest, a chat room accessible to the presentation attendees; and, at least one product gallery, wherein products within the product gallery are available for purchase by the guest.

It is, therefore, an advantage and objective of the present disclosure to provide a method and system for matching buyers and sellers online.

Specifically, it is an advantage of the present disclosure to provide an on-line, interactive group shopping and selling platform, arranged by a hostess and facilitated by a consultant, which allows friends and family to shop together wherever they may be located.

It is another advantage of the present disclosure to provide a multi-faceted event page having live meeting features, product information, chat room functionality, and a shopping cart link directly from the interactive event page.

It is yet another advantage of the present disclosure to provide a chat room feature wherein guests can share thoughts in real time on items being demonstrated and discussed during the online presentation.

It is a further advantage of the present disclosure to provide a URL text link to a friend so that the remote friend can participate in the online event and provide immediate feedback on the featured items.

It is still another advantage of the present disclosure to provide linking shopping carts for remote guests to send items to, for tracking the event in real time, and to provide a wish list for reference for future events.

It is yet another advantage of the present disclosure to provide separate URLs allowing for a plurality of stores to be shopped during a live online presentation.

Additional features and advantages of the present disclosure are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates high level process flow chart illustrating an interactive, online selling and shopping platform in accordance with an embodiment of the present disclosure;

FIG. 2 illustrates high level flow chart showing creation of a multi-faceted Event Page of the interactive, online selling and shopping platform in accordance with an embodiment of the present disclosure;

FIG. 3 illustrates a flow chart creating a shopping event on the multi-faceted Event Page of the interactive, online selling and shopping platform in accordance with an embodiment of the present disclosure;

FIG. 4 illustrates a flow chart of a shopping event on the Event Page of the interactive, online selling and shopping platform in accordance with an embodiment of the present disclosure;

### DETAILED DESCRIPTION

The present disclosure relates to systems and methods for matching buyers and sellers of goods online. Specifically, the present disclosure provides a hybrid system and method between the traditional in-home, in-person “Tupperware party” style of selling, and the online, non-interactive style of selling and purchasing found on the Internet. Thus, the present system and method offers an online, interactive platform, where shoppers can browse and shop together interactively, during a live, online event, no matter where they are located. Additionally, the present platform includes a plurality of URLs connected to a single online selling/shopping platform that can be accessed by a plurality of remote shoppers and guests, which facilitates the shopping experience in real time.

The present system connects merchant websites with remote consumers and guests through known systems, devices and servers. For example, the network may be a global area network, such as the Internet, a local area network, or a combination of networks. It should be understood that remote customers, using their own electronic devices, including personal computers, mobile devices, tablets and smartphones, connect through the network to the server of the merchant website to access the shopping/selling platform of the present disclosure.

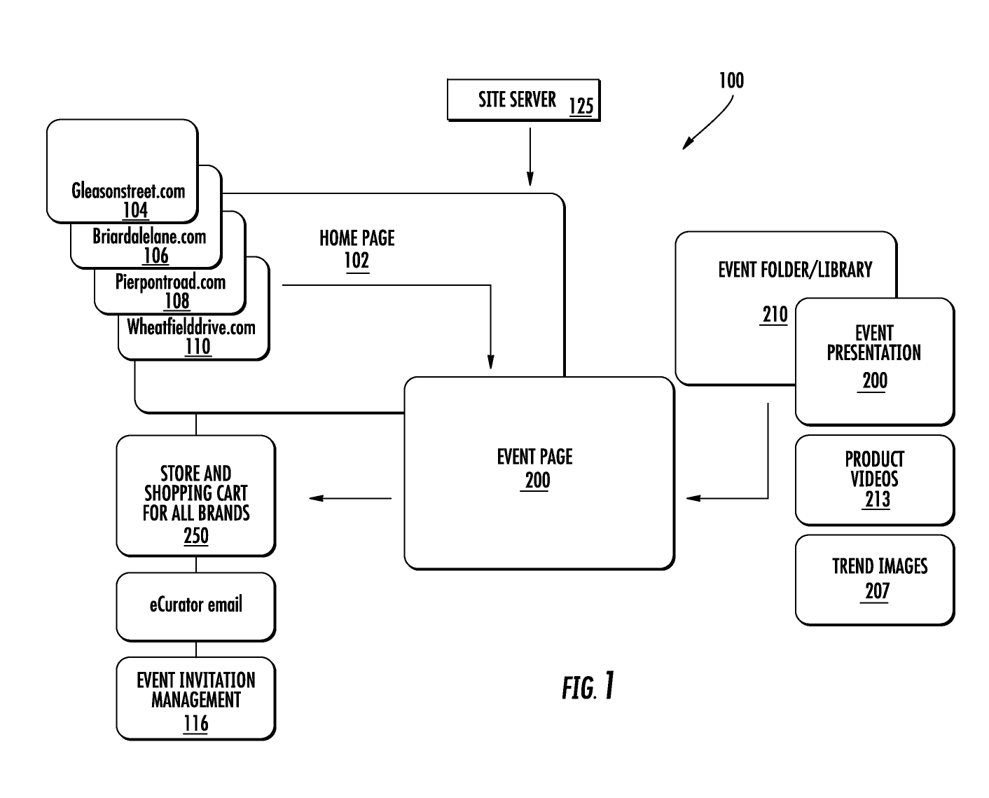

Now referring to the figures, FIG. 1 illustrates a high level process flow for a web-based system for an interactive, social shopping platform 100, which is housed on an electronic device, including a merchant server. Generally, the system includes a site Home Page 102 and an interactive, multifaceted Event Page 200. The Home Page 102 further includes multiple web-based Store Front Pages, each having a unique URL. In this embodiment, four Store Front or Brand Pages 104, 106, 108 and 110, are shown. Each Store Front or Brand Page features different items, including but not limited to, home goods and accessories, children's toys and activity items, kitchen and culinary tools and equipment, and personal accessories and jewelry. However, it should be understood that there could be any number of Store Front of Brand Pages within the Home Page.

The Home Page 102 may also include links to other standard informational pages, including links to various other locations within the Home Page, including “About Us,” “Host an Event,” “Join the Neighborhood (become a consultant),” “Trends,” and “Artisans/Brands.” The Home Page 102 may also include specific log-in links for consultants and hostesses, as well as for guests/customers.

Each Store Front Page has its own URL, permitting access to the store. Optionally, Store Front Pages can be accessed through a link on the Home Page 102. Optionally, each Store Front Page may be accessed through links on other Store Front Pages. In one embodiment, the Store Front Page 106 may include the following links: “Host a Show,” “Join the Neighborhood,” “Featured Artisan,” “Current Promotion,” and “Home Page.” Each link opens to information relating to artisan or merchant information, product categories, hosting a show, including links to support the event such as email and invitation development, and joining the neighborhood (becoming a consultant) relating to a particular store. Each Store Front of Brand Page 106 categorizes the products being offered, for example, clothing, housewares, toys, jewelry, etc. The products can be offered through multiple suppliers and brands. It should be noted that the Store Fronts Pages are accessible to the remote customer anytime for viewing and shopping, similar to other online shopping sites, and not just during an online party or presentation.

Unlike other online shopping sites, the online selling and shopping platform of the present disclosure provides an interactive, multi-faceted Event Page 200 (FIG. 1). The Event Page 200 can be accessed through the Home Page 102, or alternatively, each of the Store Front Pages 104-110 of the present embodiment. The Event Page 200 is a complete interactive page, which enables the following functions: real-time, live meeting or event presentations of products, interactive chat room and shopping cart functionality.

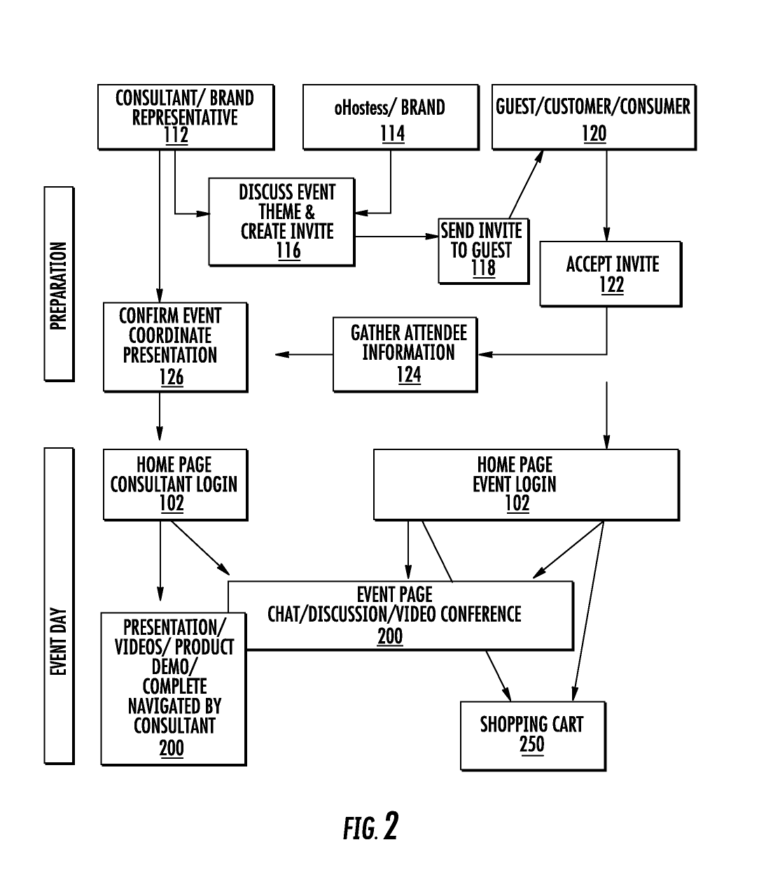

FIG. 2 illustrates a process flow of creating a shopping/selling event through the Event Page of the online, interactive selling and shopping platform of the present disclosure. Preparation 100a or creating a shopping/selling event includes the coordination of a consultant/brand representative 112, and a host 114, who together create a themed event and invitation 116 for a particular product or products to be shown during the event. The next step includes sending the invitation 118 to at least one remote guest or consumer 120. The guest accepts the invitation 122. In the next step 124, the attendee information is gathered, and the event is confirmed and coordinated 126.

On the day of the shopping event, the consultant 112, logs in 128 to the Home Page 102 through a network server 125 (FIG. 1). Additionally, the invited remote guest(s) 120, using a personal electronic device, log in through a network server 125 to the Home Page 102 and enter the Event Page 200 to attend the online, live interactive shopping and selling event, and the ability to link to remote shopping carts 250.

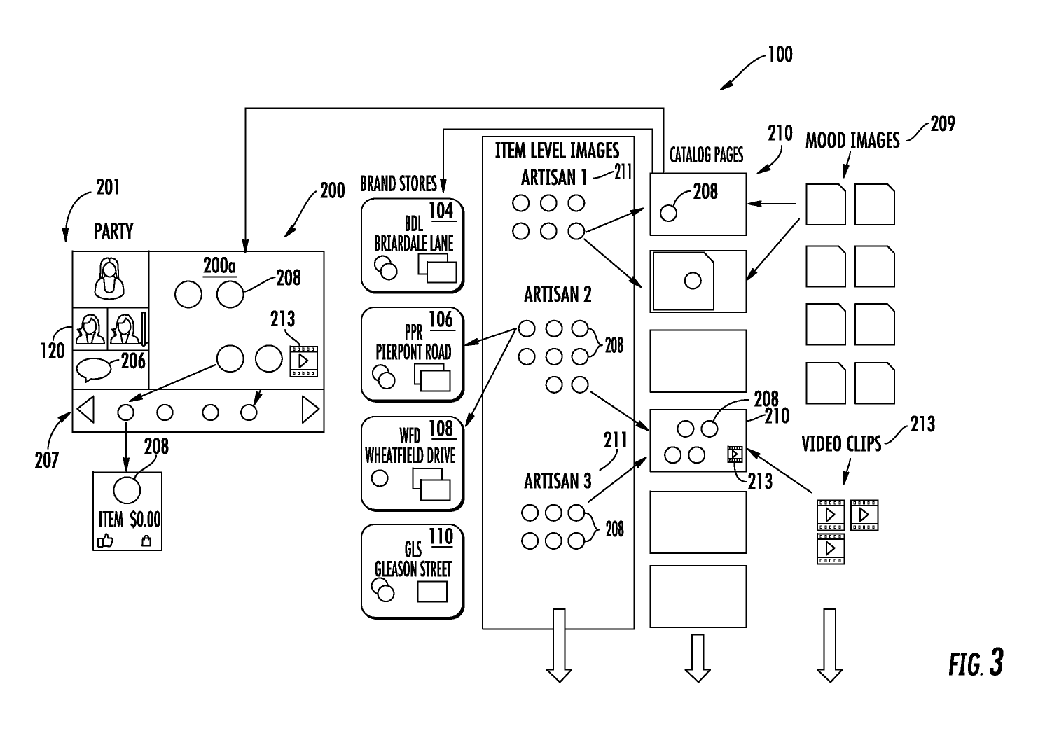

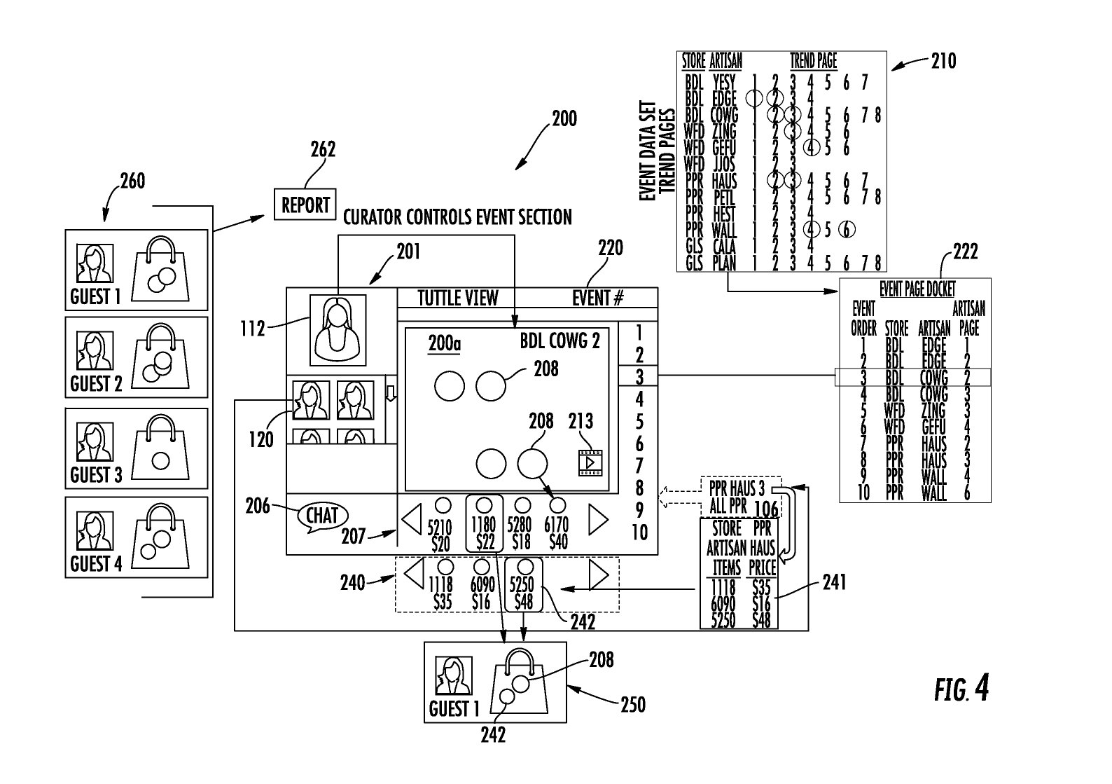

FIGS. 3 and 4 illustrate in detail the process flow for creation of an Event Page 200 and the Event Page in use during the online, real time shopping and selling presentation or party. FIG. 3 illustrates the process flow for creation of the Event Page 200. As will be discussed in detail, the Event Page includes several elements. Initially, there is a product presentation area 200a, where the product images 208, which may also include video clips 213, are presented. Second, there is a video conferencing section 201, which includes live video of the attendees of the presentation, including the consultant/curator 112, the remote guest or guests 120, and the host/hostess 114. Third, there is a chat room 206 for use by all attendees. Finally, there is scroll bar 207 or gallery, where individual product images 208 from the presentation are shown and which can be placed into a remote shopping cart 250.

As shown in FIG. 3, creating the Event Page 200 and the party to be given on the Event Page, begins with creating a series or library of catalog pages 210. The library of catalog pages 210 incorporate a variety of item or product images 208. The item of product images 208 are selected from the various artisans or brands 211, which are available from their own separate libraries, and/or from one or more of the Store Front or Brand Pages 104-110. One artisan's products may be in more than one Store Front Page. One catalog page 210 may have items from more than one artisan or brand 211, or an artisan or brand item 208 may go into more than one catalog page 210. The product images 208 and mood images or background images 209 (which may be used on more than one catalog page), as well as video clips 213, showing product demonstrations, can all be loaded into the catalog pages 210. The catalog pages 210 may also be available for viewing in appropriate Store Front Pages for the products chosen for that particular catalog page.

The catalog pages 210 are then used to “feed” the Event Page 200 and create a personalized event or party, the live video feed 201 of the party attendees. As illustrated in FIG. 4, the series or library of catalog pages 210, are used to populate and create a plurality of personalized events 220. In this specific embodiment, there are ten possible catalog pages to create the personalized event 220 that can take place on this Event Page 200. Using the library of catalog pages 210, a specific event page docket 222 is loaded to create the personalized event. The highlighted number 3 designates the third page in the series of pages of products for that particular event 220.

Referring now to FIG. 4, the online presentation or party is shown on the Event Page 200. The Event Page 200 includes a live video feed section 201, which includes the consultant 112 and the remote guests 120. Just as in a live, in-person party, the consultant 112 shows and demonstrates the products 208 from that particular event 222 on the presentation area 200a of the Event Page 200. The consultant 112 facilitates the event and controls what images are loaded into the presentation area 200a of the Event Page 200 from the series of catalog pages 210, moving through and demonstrating products, just like during a traditional in-person party event. In addition to showing the product images 208, the consultant 112 can also load video clip demonstrations 213 of the particular item being shown. This live demonstration of the products and participation by the remote guests via discussion of chat room 206 gives the present system 100 the feeling of a traditional “Tupperware” style in-home party, with the unique feature that the consultant 112 and guests 120 can attend the party from anywhere.

During the event, the product images 208 can appear below the Event Page 200 in a first scroll or gallery bar 207. Product images 208 can be placed into the first scroll or gallery bar 207 by the guests, who have separate, individual control through their own personal electronic devices of the product images. The consultant cannot access this scroll or gallery bar 207. Guests 120 can also place items into a remote shopping cart 250 directly from the Event Page 200.

FIG. 4 illustrates another unique feature of the present system, wherein the guest or guests 120 have the ability to control what product images 208 he/she is viewing, and has the option to purchase both during, as well as, separately from the presentation going on within the Event Page 200. Specifically, the guest 120 can access a second scroll or gallery bar 240, which is separate from the first scroll bar 207 that is populated with products 241 the guest pulls from another event page catalog. In this embodiment, the guest 120 may access items from other event catalog pages even if the consultant has moved away from that particular page. With each connection to a different event catalog page, the guest will have access to the products in the second scroll gallery bar or gallery 240. The guest 120 then has the ability to pull items from the first presentation scroll or gallery bar 207 and/or the separate second scroll bar 240 to populate the shopping cart 250 for further purchase. The key feature is that the guest 120 has the ability to control the purchase activity, as well as what the guest decides to view, whether it be the presentation being given in the Event Page 200 or looking through separate associated catalog pages 210 or Store Front Pages.

As shown in FIGS. 3 and 4, the Event Page 200 also includes a chat room 206. Although chat rooms are generally known, where multiple parties can participate in a real-time discussion on a particular topic, the present chat room 206 is unique to the online selling and shopping platform 100, and specifically, the Event Page 200 of the present disclosure. The chat room 206, which is controlled by the remote guests, allows the guests to share real-time thoughts and opinions on the item(s) and/or product images 208 being demonstrated and discussed on the Event Page 200 during the party. As shown, multiple guests 210 can participate in the chat within the chat room 206, just as they would if they were all sitting together at the hostess' house during an onsite, in-person party event. However, the advantage of the present system 100 is that the consultant 112 and guests 210 are all linked together, through various electronic devices through a network to a server of a website, so that the remote guests can shop together online, during live video feed and demonstrations, no matter where they are located.

The present online selling and shopping platform system 100 may include an option for guests 120 on the Event Page 200 attending a live presentation to contact remote friends and/or relatives for his or her feedback on particular products, and even participation in the current online shopping event. The Event Page 200 may include link with “Text URL to Friend” capability, for instant sharing, conversation and shopping, while the event takes place. Through this link, a guest attending the online party can contact a remote friend or relative for instant feedback on products being viewed. The remote friend can also be invited by the guest to participate in the event.

As shown in FIG. 4, the guest shopping carts 250 can be grouped together 260 to create the data for a report 262 on the event. A variety of information can be provided by each cart, and together the system permits calculations of items sold and purchased by the guests to determine an accounting and success of a particular event. For example, the guest shopping cart 250 may include the item or items selected for purchase, options to place items in a wish list for future reference and possible purchase, the consultant name and contact information, the guest name and contact information, and the hostess name and contact information, among other information. Additional data may include reference to other shows, calculations of commissions, totals of specific items sold, and other financial information that may be relevant to calculating the overall success of the party.

In addition, the present online social shopping platform system 100 and method is capable of providing information relating to customer history, including guest views, purchases and wish list, information relating to hostess history, including show history and personal purchase history, and information relating to consultant history, including show history, hostess history, customer history and item level detail by hostess and by consultant.

Other features of the present system may include reporting functions. For the guest/customer, these features may include purchase history and wish lists. For the hostess, these features may include show history and personal purchase history. For the consultant, these features may include show history, hostess history, customer history, and item level detail by hostess and consultant.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A method for providing an on-line interactive shopping platform, comprising the steps of:
providing a merchant electronic computing device in connection with a server;
defining a website with multiple storefront domains housed within the merchant electronic computing device;
offering a multi-faceted event page, the event page being viewable on the merchant electronic computing device by at least one remote consumer;
offering at least one product viewable within each event page; and,
providing a live link within the event page wherein at least one remote consumer having an electronic device can connect through the server to the live link and enter the event page, wherein the remote consumer can visit, comment on an item and make a purchase during a live presentation.

2. The method of claim 1 further comprising accessing the multiple storefronts by at least one remote consumer through the remote consumer's electronic device.

3. The method of claim 1, wherein the product page includes providing a link for sending a URL address from a first remote consumer on a first electronic device to second remote consumer on a second electronic device.

4. The method of claim 3, wherein the link further provides interactive viewing and commenting on a particular product within the product page by a plurality of remote consumers.

5. The method of claim 1 further comprising activating a live video presentation by a consultant within the event page.

6. The method of claim 1 further comprising providing a chat room within the event page.

7. The method of claim 6, wherein the chat room is accessible by the remote consumers through the consumer's electronic device.

8. The method of claim 7, wherein accessing the chat room includes sharing comments from a plurality of remote consumers on the products while being displayed during the live presentation on the event page.

9. The method of claim 7 further comprising providing a separate online shopping cart accessible to the guest.

10. A system for providing an interactive group online shopping experience, the system comprising:
a merchant electronic computing device with a computer-readable program code stored therein, the merchant electronic computing device in connection with a server;
a processing device operatively coupled to the merchant electronic computing device and the server, wherein the processing device is configured to execute the computer readable code to:
create a site with multiple storefront domains within the merchant electronic computing device;
create an multi-faceted event page, the event page being viewable by at least one remote consumer;
provide at least one product image within each event page, the product image being viewable by at least one remote consumer;
provide a live link within the product page; and,
a consumer electronic computing device connecting to the merchant electronic computing device through the server, wherein the consumer can connect to the live link on the event page to view the product images during a real time presentation.

11. The system of claim 10, wherein the multi-faceted event page further includes offering live video presentations of featured products.

12. The system of claim 10, wherein the multi-faceted event page further includes a chat room accessible to the at least one remote consumer.

13. The system of claim 12, wherein the chat room is accessible in real time by a plurality of remote consumers.

14. The system of claim 10, wherein the at least one remote consumer can view, comment on, and place items in a gallery bar

15. The system of claim 14, wherein the at least one remote consumer can place items from the gallery bar into a remote shopping cart during the live presentation.

16. The system of claim 10, wherein the live link within the event page permits a remote consumer access to comment and view the product during the live presentation.

17. The system of claim 10, wherein the live link permits a remote consumer to invite another remote consumer to attend the live presentation in real time.

18. A system for providing an interactive group online shopping experience, the system comprising:
a multifaceted event page for hosting an online party in real time, the event page further comprising:
a product presentation area;
a video presentation area including a live video of attendees including a consultant and at least one guest;
a chat room accessible to the presentation attendees; and,
at least one product gallery, wherein products within the product gallery are available for purchase by the guest.

19. The system of claim 18, wherein the product presentation area provides images of products from a library of catalog pages containing products from a variety of sources.

20. The system of claim 18, wherein the product gallery can be populated by the guest with products for purchase.
